(19) United States
(12) Patent Application Publication
(10) Pub. No.: US 2009/0281714 A1
(43) Pub. Date: Nov. 12, 2009

(54) Traffic Congestion Estimation Based on Motion of Cellular Devices

(75) Inventors: Anas Youssef Boubas, Al Ain (AE); Awad Al-Khalaf, Sharjah (AE)

Correspondence Address: Dr Y Boobes, POBox 15258, Tawam Hospital, Al Ain, omitted

(73) Assignees: Anas Youssef Boubas, Al Ain (AE); Awad Al-Khalaf, Sharjah (AE)

(21) Appl. No.: 12/437,800

(22) Filed: May 8, 2009

Related U.S. Application Data
(60) Provisional application No. 61/051,759, filed on May 9, 2008.

(51) Int. Cl. G08G 1/123; H04W 24/00

(52) U.S. Cl. 701/119; 701/117; 455/456.1

(57) ABSTRACT

A mechanism for estimating the traffic congestion is invented. The mechanism relies on information about the motion of cellular devices on roads. The existing information about the motion of cellular devices is used to estimate the motionability of upcoming traffic. The system can be used to issue traffic warnings, redirect traffic to non-congested routes and derive traffic statistics for research and development.

### DETAILED DESCRIPTION OF THE INVENTION

The invention uses a Location Service (LCS) of cellular network to determine and update an estimation of the location of selected cellular devices. The variation of estimated location of the selected cellular devices by time is calculated. This variation is then used to calculate the velocity (speed and direction) of the selected cellular devices.

The velocity of the selected cellular devices is used to derive several useful statistics about the traffic status on road. One important statistic is an estimation of time needed for a newly arriving traffic to cross the road. Another statistic is related to issuing traffic warnings. A third statistic is related to route suggestion for traffic redirection and congestion control.

The use of maps services may be utilized in the process of selecting the cellular devices to which the traffic is to be calculated.

Traffic estimation is very useful for saving on-road hours. On-road hours are related to several diseases and social disasters. Decreasing the average on-road hours in a nation increases its productivity in terms of hours count and in terms of productivity per hour.

Traffic estimation may also become life saving if used in traffic control. Traffic congestion is related to traffic accidents, many of which may be fatal. Decreasing the traffic congestion can be achieved by using traffic control and redirection based on good traffic estimation.

Traffic estimation also saves money spent on fuel products. Fuels are known to be an important factor contributing to pollution and global warming. Spending less time on road translates to less use of fuel and hence less pollution.

What is claimed is:

1. A mechanism that enables effectively realizing traffic statistics. The mechanism realizes traffic statistics by calculating the change in the location of cellular devices by time. The claimed mechanism comprises:
a filtering system to remove noisy data not related to traffic flow;
utilization of connected and candidate Base Transceiver Stations;
utilization of continuous measurements unlimited to Time Advance Data; and
a velocity estimation system that estimates the velocity from the measurements provided.

2. A filtering mechanism that removes noisy data. The mechanism comprises:
removal of noisy data that includes cellular devices that are not part of on-road traffic; and
monitoring the history of the behavior of the cellular device to determine if it is on-road.

3. A pattern detection mechanism that detects on-road events. The mechanism comprises:
utilization of the motion history of one or more on-road cellular devices;
mapping the pattern of the motion history to stored patterns in a database; and
performing the action specified in the database entry of the matched pattern.
